(19) United States
(12) Patent Application Publication
(10) Pub. No.: US 2024/0355087 A1
(43) Pub. Date: Oct. 24, 2024

(54) METHOD OF MATCHING SCAN DATA BASED ON DRIVING ENVIRONMENT FEATURES OF AUTONOMOUS VEHICLE, COMPUTER DEVICE, AND RECORDING MEDIUM

(71) Applicant: RideFlux Inc., Jeju-si (KR)

(72) Inventors: Jiwoong KIM, Seoul (KR); Donghee HAN, Anyang-si (KR); Jongwoo HAN, Seoul (KR); Wooseong YANG, Seoul (KR); Sangmin KIM, Seoul (KR)

(73) Assignee: RideFlux Inc., Jeju-si (KR)

(21) Appl. No.: 18/640,990

(22) Filed: Apr. 19, 2024

(30) Foreign Application Priority Data
Apr. 21, 2023 (KR) 10-2023-0052696

(51) Int. Cl. G06V 10/75; G06V 10/44; G06V 10/762; G06V 20/56; G06V 20/58

(52) U.S. Cl. CPC G06V 10/751; G06V 10/44; G06V 10/762; G06V 20/58; G06V 20/588

(57) ABSTRACT

Provided are a method of matching scan data based on driving environment features of an autonomous vehicle, a computing device, and a recording medium. The method of matching the scan data based on the driving environment features of the autonomous vehicle according to various embodiments of the present invention that is performed by a computing device includes extracting features from a plurality of pieces of scan data in consideration of driving environment features of an autonomous vehicle and performing matching on the plurality of pieces of scan data using the extracted features.

### CROSS-REFERENCE TO RELATED APPLICATION

This application claims priority to and the benefit of Korean Patent Application No. 2023-0052696, filed on Apr. 21, 2023, the disclosure of which is incorporated herein by reference in its entirety.

### BACKGROUND

### 1. Field of the Invention

Various embodiments of the present invention relate to a method of matching scan data based on driving environment features of an autonomous vehicle, a computing device, and a recording medium.

### 2. Discussion of Related Art

For convenience of users driving vehicles, various types of sensors and electronic devices (e.g., advanced driver-assistance systems (ADASs)) are increasingly being provided, and in particular, technological development is being actively conducted on autonomous driving systems for vehicles that recognize the surrounding environment without a driver's intervention and allow the vehicles to automatically travel to given destinations according to the recognized surrounding environment.

An autonomous vehicle is a vehicle equipped with functions of an autonomous driving system that recognizes the surrounding environment without a driver's intervention and allows the vehicle to automatically travel to a given destination according to the recognized surrounding environment, and the functions of the autonomous driving system mean performing localization, recognition, prediction, planning, and control for autonomous driving.

Here, the localization is one element technology of autonomous driving and is an operation of recognizing an exact position and attitude of an autonomous vehicle, and the autonomous driving system uses a map of an area where the autonomous vehicle will travel to perform localization for the autonomous vehicle.

As representative localization technology for autonomous vehicles, there is technology using light detection and ranging (LiDAR) sensors. A LiDAR sensor uses a technology for measuring a distance or speed of an object or determining the type or shape of the object by illuminating the light of a laser on the distant object to detect the light reflected from the object.

When using a LiDAR sensor, an autonomous vehicle generates data by scanning the surrounding environment, such as the road or the like on which the autonomous vehicle is located, and compares the generated scan data with information about a precision map to recognize the position of the autonomous vehicle on the precision map. Here, the process of comparing the scan data collected from the autonomous vehicle with the information about the precision map or a process of comparing two or more pieces of scan data collected at consecutive time points is referred to as a scan data matching process.

Such a scan data matching process may be used in a variety of ways in the field of autonomous driving, such as mapping, in which a precise map is built by finding correspondences between and matching two or more pieces of scan data, as well as localization for autonomous vehicles, and thus it is necessary to perform a process of matching scan data more accurately in order to implement highly reliable autonomous driving.

Meanwhile, since the conventional scan data matching algorithm is not an algorithm specialized for the driving environment of autonomous vehicles, but is an algorithm designed to match scan data collected by scanning various environments (e.g., not only roads, but also aviation, rugged outdoor environments, indoors, etc.), that is, an algorithm designed in consideration of versatility, the conventional scan data matching algorithm has an advantage of being applicable to various fields, but has a problem of poor performance in terms of computational amount, accuracy, and robustness when applied to a specific field such as autonomous driving.

### SUMMARY OF THE INVENTION

The present invention is directed to providing a method of matching scan data based on driving environment features of an autonomous vehicle, in which, by extracting features from scan data in consideration of driving environment features of an autonomous vehicle and matching the scan data on the basis of the extracted features, scan data matching optimized for the driving environment of the autonomous vehicle can be performed, and through this, performance in terms of calculation amount, accuracy, and robustness can be improved, a computing device, and a recording medium.

Objects of the present invention are not limited to the above-described objects and other objects which have not been described may be clearly understood by those skilled in the art from the above descriptions.

According to an aspect of the present invention, there is provided a method of matching scan data based on driving environment features of an autonomous vehicle that is performed by a computing device, which includes extracting features from a plurality of pieces of scan data in consideration of driving environment features of an autonomous vehicle and performing matching on the plurality of pieces of scan data using the extracted features.

The extracting of the features may include generating ground data and non-ground data by dividing scan points corresponding to a ground surface among a plurality of scan points included in specific scan data, extracting a first feature from the generated ground data, and extracting a second feature from the generated non-ground data.

The extracting of the first feature may include setting a feature extraction area on the generated ground data on the basis of a type of sensor that collects the specific scan data and a position of the sensor, extracting at least one scan point whose intensity is greater than or equal to a predetermined value from among a plurality of scan points included in the set feature extraction area, and extracting at least one of the extracted at least one scan point and an edge generated by the extracted at least one scan point as the first feature.

The extracting of the second feature may include generating a plurality of clusters by clustering a plurality of scan points included in the generated non-ground data, selecting a cluster whose intensity is greater than or equal to a predetermined value from among the plurality of generated clusters, and when scan points included in the selected cluster are distributed in a form of a plane, extracting the selected cluster as the second feature.

The extracting of the selected cluster as the second feature may include calculating a covariance matrix for the scan points included in the selected cluster, wherein the calculated covariance matrix includes three eigenvalues corresponding to each of three mutually perpendicular axis directions, and when sizes of two of the three eigenvalues are greater than or equal to a threshold value and a size of the remaining one eigenvalue is less than the threshold value, extracting a plane generated by the scan points included in the selected cluster as the second feature.

The extracting of the second feature may include generating a plurality of clusters by clustering a plurality of scan points included in the generated non-ground data, selecting a cluster including a predetermined number or more of scan points from among the plurality of generated clusters, and when scan points included in the selected cluster are distributed in a form of a pole, extracting the selected cluster as the second feature.

The extracting of the selected cluster as the second feature may include calculating a covariance matrix for the scan points included in the selected cluster, wherein the calculated covariance matrix includes three eigenvalues corresponding to each of three mutually perpendicular axis directions, and when a size of one of the three eigenvalues is greater than or equal to a first threshold value and sizes of the remaining two eigenvalues are less than a second threshold value smaller than the first threshold value, extracting an edge generated by the scan points included in the selected cluster as the second feature.

The extracting of the selected cluster as the second feature may include, when a z-axis component value of a unit vector in a long-axis direction of the distribution of the scan points included in the selected cluster is greater than or equal to a preset value, extracting an edge generated by the scan points included in the selected cluster as the second feature.

The extracting of the selected cluster as the second feature may include, when distances between two or more clusters extracted as the second feature are less than or equal to a predetermined distance, removing remaining clusters except for any one of the two or more clusters.

The plurality of pieces of scan data may include first scan data collected at a first time point and second scan data collected at a second time point after the first time point, and in the performing of the matching, a relative transformation between a coordinate system of the first scan data and a coordinate system of the second scan data may be derived by matching a feature extracted from the first scan data with a feature extracted from the second scan data, wherein the feature extracted from the first scan data and the feature extracted from the second scan data may include the features extracted from the first scan data and the second scan data in consideration of the features that are already extracted from the first scan data and the second scan data without considering the driving environment features of the autonomous vehicle, and of the driving environment features of the autonomous vehicle.

The plurality of pieces of scan data may include the first scan data and the second scan data, and the performing of the matching may include finding correspondences between a plurality of features extracted from the first scan data and a plurality of features extracted from the second scan data on the basis of distances between the plurality of features extracted from the first scan data and the plurality of features extracted from the second scan data, and matching the first scan data with the second scan data using the distances between the plurality of features extracted from the first scan data and the plurality of features extracted from the second scan data that correspond to each other as a cost function so that a cost of the cost function has a minimum value.

According to another aspect of the present invention, there is provided a computing device for performing a method of matching scan data based on driving environment features of an autonomous vehicle, which includes a processor, a network interface, a memory, and a computer program that is loaded into the memory and executed by the processor, wherein the computer program includes an instruction for extracting features from a plurality of pieces of scan data in consideration of driving environment features of an autonomous vehicle, and an instruction for performing matching on the plurality of pieces of scan data using the extracted features.

According to still aspect of the present invention, there is provided a computer program, which is stored in a recording medium readable by a computing device that is combined with a computing device to perform a method of matching scan data based on driving environment features of an autonomous vehicle that includes extracting features from a plurality of pieces of scan data in consideration of driving environment features of an autonomous vehicle and performing matching on the plurality of pieces of scan data using the extracted features.

Other specific details of the present invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an autonomous driving system according to an embodiment of the present invention;

FIG. 2 is a diagram illustrating a hardware configuration of a computing device that performs a method of matching scan data based on driving environment features of an autonomous vehicle according to another embodiment of the present invention;

FIG. 3 is a flowchart of a method of matching scan data based on driving environment features of an autonomous vehicle according to still another embodiment of the present invention;

FIG. 4 is a flowchart for describing a method of extracting features corresponding to road markers from ground data in various embodiments;

FIG. 5 is a flowchart for describing a method of extracting features corresponding to road traffic signs from non-ground data in various embodiments;

FIG. 6 is a view showing an example of results of extracting features corresponding to road traffic signs from non-ground data in various embodiments;

FIG. 7 is a flowchart for describing a method of extracting features corresponding to pole-like objects from non-ground data in various embodiments;

FIG. 8 is a view showing an example of results of extracting features corresponding to pole-like objects from non-ground data in various embodiments; and

FIG. 9 is a view showing results of matching a plurality of pieces of scan data in various embodiments.

### DETAILED DESCRIPTION OF EXEMPLARY EMBODIMENTS

Advantages and features of the present invention and methods of achieving the same will be clearly understood with reference to the accompanying drawings and embodiments described in detail below. However, the present invention is not limited to the embodiments to be disclosed below but may be implemented in various different forms. The embodiments are provided in order to fully explain the present embodiments and fully describe the scope of the present invention for those skilled in the art. The scope of the present invention is only defined by the appended claims.

Terms used in this specification are considered in a descriptive sense only and not for purposes of limitation. In this specification, singular forms include plural forms unless the context clearly indicates otherwise. It will be understood that the terms “comprise” and/or “comprising,” when used herein, specify some stated components but do not preclude the presence or addition of one or more other components. Like reference numerals indicate like components throughout the specification and the term “and/or” includes each and all combinations of one or more referents. It should be understood that, although the terms “first,” “second,” etc. may be used herein to describe various components, these components are not limited by these terms. The terms are only used to distinguish one component from another component. Therefore, it should be understood that a first component to be described below may be a second component within the technical scope of the present invention.

Unless otherwise defined, all terms (including technical and scientific terms) used herein can be used as is customary in the art to which the present invention belongs. Also, it will be further understood that terms, such as those defined in commonly used dictionaries, will not be interpreted in an idealized or overly formal sense unless expressly so defined herein.

Terms described in the specification such as “unit” or “module” refer to software or a hardware component such as a field-programmable gate array (FPGA) or an application-specific integrated circuit (ASIC), and a “unit” or “module” performs certain functions. However, a “unit” or “module” is not limited to software or hardware. A “unit” or “module” may be included in an addressable storage medium or may be executed by at least one processor. Therefore, examples of a “unit” or “module” include components such as software components, object-oriented software components, class components and task components, processes, functions, attributes, procedures, subroutines, segments of program code, drivers, firmware, micro code, circuits, data, databases, data structures, tables, arrays, and variables. Components and functions provided in “units” or “modules” may be combined into a smaller number of components and “units” or “modules” or may be further separated into additional components and “units” or “modules.”

Spatially-relative terms such as “below,” “beneath,” “lower,” “above,” and “upper” may be used herein for ease of description to describe the relationship of one element or component with another element(s) or component(s) as illustrated in the drawings. Spatially relative terms should be understood to include different directions of the element during use or operation in addition to the direction illustrated in the drawing. For example, if the element in the drawings is turned over, elements described as “below” or “beneath” other elements would then be oriented “above” the other elements. Therefore, an exemplary term “below” may encompass both orientations of above and below. Elements may also be oriented in other orientations, and thus spatially relative terms may be interpreted according to orientation.

In this specification, a computer is any type of hardware device including at least one processor and may be understood with a comprehensive meaning that includes software configurations operating in the corresponding hardware device according to embodiments. For example, the computer may be understood with a meaning that includes a smart phone, a tablet personal computer (PC), a desktop computer, a notebook computer, and a user client and application running on each device, but the present invention is not limited thereto.

Hereinafter, embodiments of the present invention will be described in detail with reference to the accompanying drawings.

Each operation described in this specification is described as being performed by a computer, but a subject of each operation is not limited thereto, and at least a portion of each operation may be performed in different devices according to embodiments.

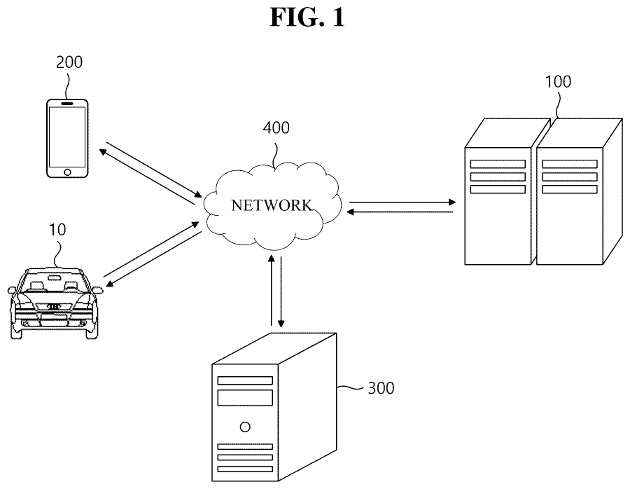

FIG. 1 is a diagram illustrating an autonomous driving system according to an embodiment of the present invention.

Referring to FIG. 1, the autonomous driving system according to the embodiment of the present invention may include a computing device 100, a user terminal 200, an external server 300, and a network 400.

Here, the autonomous driving system illustrated in FIG. 1 is a system according to an embodiment, and components of the system are not limited to those in the embodiment illustrated in FIG. 1 and may be added, changed, or removed as necessary.

In an embodiment, the computing device 100 may perform various types of operations for autonomous driving control of an autonomous vehicle 10.

In various embodiments, the computing device 100 may perform a localization operation of measuring a position and attitude of the autonomous vehicle 10. For example, the computing device 100 may collect scan data by scanning the surrounding environment of the autonomous vehicle 10 through a sensor provided inside the autonomous vehicle 10, and determine the position and attitude of the autonomous vehicle 10 by utilizing the collected scan data.

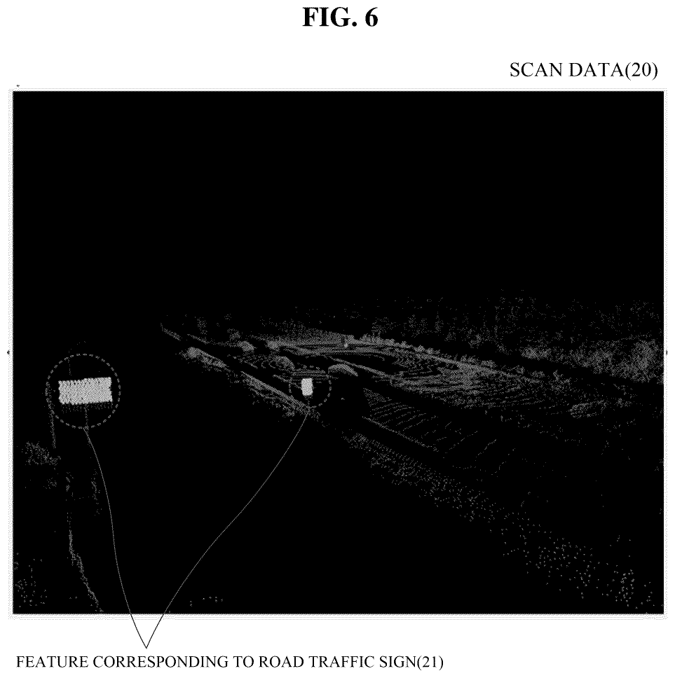

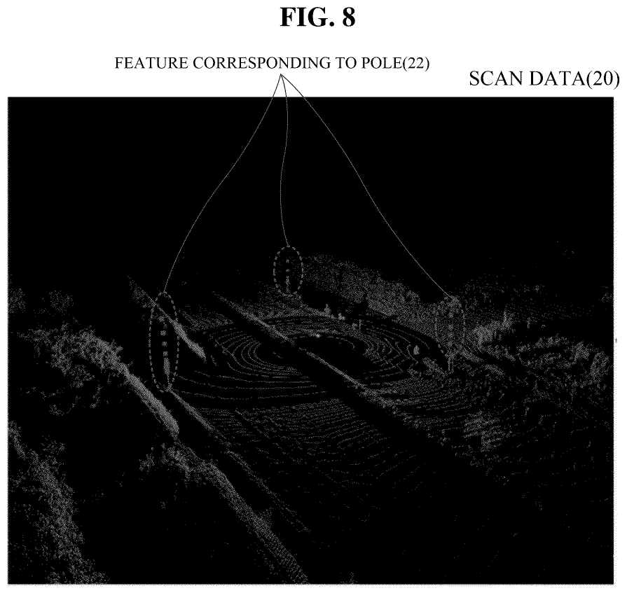

Here, the scan data may be sensor data in the form of a point cloud (e.g., 20 in FIG. 6 and FIG. 8) collected as a predetermined space is scanned through a sensor (e.g., a light detection and ranging (LiDAR) sensor), but the present invention is not limited thereto, and the scan data may be a precision map in the form of a point cloud generated by processing sensor data collected in advance for a predetermined space.

For example, the computing device 100 may determine the position and attitude of the autonomous vehicle 10 by matching scan data in the form of a point cloud collected in real time through the autonomous vehicle 10 traveling in a predetermined area with a precision map in the form of a point cloud generated in advance for the predetermined area, or determine the position and attitude of the autonomous vehicle 10 by matching two or more pieces of scan data collected at different time points through the autonomous vehicle 10.

Here, information about the position of the autonomous vehicle 10 may be coordinate values corresponding to the position of the autonomous vehicle 10, and information about the attitude of the autonomous vehicle 10 may be a quaternion value or each of Euler values (e.g., pitch, roll, and yaw) that correspond to the attitude of the autonomous vehicle 10, but the present invention is not limited thereto.

Further, the computing device 100 may build a precision map for autonomous driving control of the autonomous vehicle by performing mapping for finding correspondences between and matching two or more pieces of scan data on the basis of a method of matching scan data based on driving environment features of an autonomous vehicle according to various embodiments of the present invention.

In various embodiments, the computing device 100 may match two or more pieces of scan data using features extracted from two or more different pieces of scan data, and extract features in consideration of driving environment features of the autonomous vehicle 10.

Here, the driving environment features that are considered in extracting the features from the scan data are as follows.

First, the autonomous vehicle 10 travels along the ground surface.

Second, there are various types of road markers such as lane lines, center lines, safety zones, crosswalks, speed limits, stops, temporary stops, yield signs, speed warnings, directions, etc. on the ground surface, and the road markers have a somewhat high reflectivity because of being marked through paint or the like.

Third, except for some objects (e.g., bridges, overpasses, etc.), most objects are in contact with the ground surface.

Fourth, since the heights (e.g., vertical direction or z-axis values) of objects present in the driving environment of the autonomous vehicle 10 are much smaller values than the size of the ground surface (x-y plane), when viewed macroscopically from the perspective of the ground surface, it is possible to ignore the heights of objects present in the driving environment and the driving environment can be present on a two-dimensional (2D) plane.

Fifth, in the driving environment of the autonomous vehicle 10, there are many pole-like objects such as trees, electric poles, traffic lights, etc.

Lastly, road traffic signs (e.g., caution signs, regulatory signs, instruction signs, auxiliary signs, etc.) present in the driving environment of the autonomous vehicle 10 have high reflectivity and have mostly planar shapes.

That is, in the method of matching the scan data based on the driving environment features of the autonomous vehicle 10 according to various embodiments of the present invention, features corresponding to poles, road traffic signs, and road markers may be extracted from the scan data in consideration of the driving environment features and the scan data may be matched by actively utilizing the extracted features, and thus the scan data may be matched more rapidly and accurately through matching optimized for the driving environment of the autonomous vehicle 10.

In various embodiments, the computing device 100 may be connected to the user terminal 200 through the network 400, and may provide localization results (e.g., position and attitude of the autonomous vehicle 10) that are derived by performing localization on the autonomous vehicle 10 to the user terminal 200.

Here, the user terminal 200 may be an infotainment system installed inside the autonomous vehicle 10, but the present invention is not limited thereto, and the user terminal 200 is a wireless communication device that ensures portability and mobility and may be a portable terminal that can be carried by a passenger inside the autonomous vehicle 10. For example, examples of the user terminal 200 may include all types of handheld-based wireless communication devices such as navigation systems, personal communication service (PCS) systems, Global System for Mobile Communications (GSM) systems, Personal Digital Cellular (PDC) systems, Personal Handy-phone Systems (PHSs), personal digital assistants (PDAs), International Mobile Telecommunications (IMT)-2000 systems, code division multiple access (CDMA)-2000 systems, wideband CDMA (W-CDMA) systems, wireless broadband internet (WiBro) terminals, smartphones, smart pads, tablet personal computers (PCs), etc., but the present invention is not limited thereto.

Further, here, the network 400 may be a connection structure that allows information to be transmitted or received between nodes, such as a plurality of terminals and servers. For example, examples of the network 400 may include a local area network (LAN), a wide area network (WAN), the Internet (e.g., the World Wide Web (WWW)), wired and wireless data communication networks, a telephone network, wired and wireless television communication networks, etc.

Further, here, examples of the wireless data communication network may include the 3^{rd} Generation (3G) communication network, the 4^{th} Generation (4G) communication network, the 5^{th} Generation (5G) communication network, the 3^{rd} Generation Partnership Project (3GPP) communication network, the 5^{th} Generation Partnership Project (5GPP) communication network, the Long Term Evolution (LTE) network, the World Interoperability for Microwave Access (WiMAX) network, Wi-Fi, the Internet, a LAN, a wireless LAN, a WAN, a personal area network (PAN), radio frequency (RF), a Bluetooth network, a near-field communication (NFC) network, a satellite broadcasting network, an analog broadcasting network, a digital multimedia broadcasting (DMB) network, etc., but the present invention is not limited thereto.

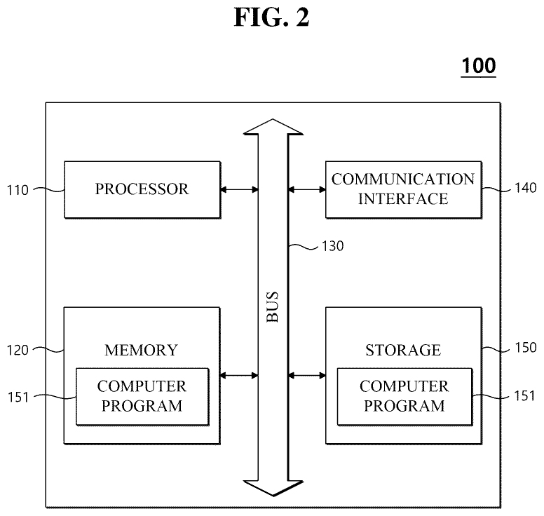

In an embodiment, the external server 300 may be connected to the computing device 100 through the network 400, and may store and manage various types of information and data necessary for the computing device 100 to perform the method of matching the scan data based on the driving environment features of the autonomous vehicle or may receive, store, and manage various types of information generated as the computing device 100 performs the method of matching the scan data based on the driving environment features of the autonomous vehicle. For example, the external server 300 may be a storage server separately provided outside the computing device 100, but the present invention is not limited thereto. Hereinafter, a hardware configuration of the computing device 100 that performs the method of matching the scan data based on the driving environment features of the autonomous vehicle will be described with reference to FIG. 2.

FIG. 2 is a diagram illustrating a hardware configuration of a computing device that performs a method of matching scan data based on driving environment features of an autonomous vehicle according to another embodiment of the present invention.

Referring to FIG. 2, in various embodiments, the computing device 100 may include one or more processors 110, a memory 120 for loading a computer program 151 executed by the processor 110, a bus 130, a communication interface 140, and a storage 150 for storing the computer program 151. Here, only the components related to the embodiment of the present invention are illustrated in FIG. 2. Therefore, it can be seen by those skilled in the art to which the present invention pertains that general-purpose components may be further included in addition to the components illustrated in FIG. 2.

The processor 110 controls the overall operation of each component of the computing device 100. The processor 110 may include a central processing unit (CPU), a microprocessor unit (MPU), a micro controller unit (MCU), a graphics processing unit (GPU), or any type of processor well known in the art to which the present invention pertains.

Further, the processor 110 may perform an operation for at least one application or program for executing methods according to embodiments of the present invention, and the computing device 100 may include one or more processors.

In various embodiments, the processor 110 may further include a random-access memory (RAM) (not illustrated) and a read-only memory (ROM) (not illustrated) for temporarily and/or permanently storing signals (or data) to be processed inside the processor 110. Further, the processor 110 may be implemented in the form of a system on a chip (SoC) including at least one of a GPU, a RAM, and a ROM.

The memory 120 is configured to store various types of data, commands, and/or information. The computer program 151 is loaded into the memory 120 from the storage 150 to execute methods/operations according to various embodiments of the present invention. When the computer program 151 is loaded into the memory 120, the processor 110 may perform the methods/operations by executing one or more instructions constituting the computer program 151. The memory 120 may be implemented as a volatile memory such as a RAM, but the technical scope of the present invention is not limited thereto.

The bus 130 provides a communication function between the components of the computing device 100. The bus 130 may be implemented as various types of buses such as an address bus, a data bus, a control bus, and the like.

The communication interface 140 supports wired/wireless Internet communication of the computing device 100. Further, the communication interface 140 may support various communication methods other than the Internet communication. To this end, the communication interface 140 may include a communication module well known in the art to which the present invention pertains. In some embodiments, the communication interface 140 may be omitted.

The storage 150 may be configured to non-temporarily store the computer program 151. When the computing device 100 performs a process of matching scan data based on driving environment features of an autonomous vehicle, various types of information necessary to provide the process of matching the scan data based on the driving environment features of the autonomous vehicle may be stored in the storage 150.

The storage 150 may include a non-volatile memory such as a ROM, an erasable programmable ROM (EPROM), an electrically erasable programmable ROM (EEPROM), a flash memory, or the like, a hard disk, a removable disk, or any type of computer-readable recording medium well known in the art to which the present invention pertains.

The computer program 151 may include one or more instructions that, when loaded into the memory 120, cause the processor 110 to perform the methods/operations according to various embodiments of the present invention. That is, the processor 110 may perform the methods/operations according to various embodiments of the present invention by executing the one or more instructions.

In an embodiment, the computer program 151 may include one or more instructions for performing the method of matching the scan data based on the driving environment features of the autonomous vehicle that includes extracting features from a plurality of pieces of scan data in consideration of the driving environment features of the autonomous vehicle and performing matching on the plurality of pieces of scan data using the extracted features.

The operations of the method or algorithm described in relation to the embodiment of the present invention may be implemented directly in hardware, may be implemented as a software module executed by hardware, or may be implemented by a combination thereof. The software module may reside in a RAM, a ROM, an EPROM, an EEPROM, a flash memory, a hard disk, a removable disk, a compact disc read-only memory (CD-ROM), or any type of computer-readable recording medium well known in the art to which the present invention pertains.

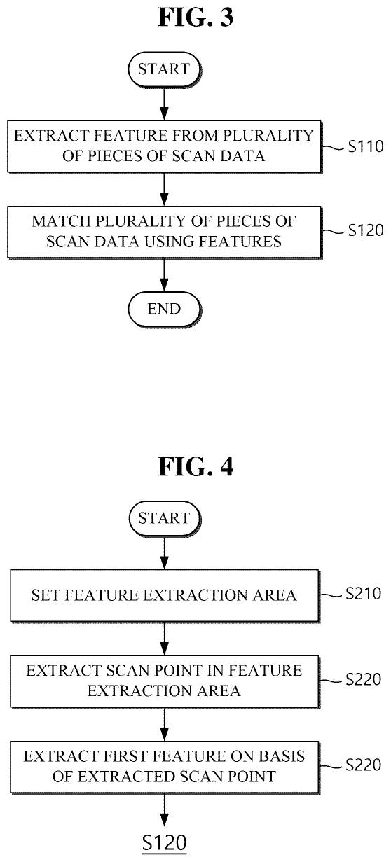

The components of the present invention may be implemented as a program (or application) in order to be executed in combination with a computer, which is hardware, and may be stored in a medium. The components of the present invention may be implemented as software programming or software components, and similarly, the embodiments may be implemented with programming or scripting languages such as C, C++, Java, assembler, etc., including various algorithms implemented as data structures, processes, routines, or combinations of other programming components. Technical aspects may be implemented with an algorithm running on one or more processors. Hereinafter, the method of matching the scan data based on the driving environment features of the autonomous vehicle performed by the computing device 100 will be described with reference to FIGS. 3 to 9.

FIG. 3 is a flowchart of a method of matching scan data based on driving environment features of an autonomous vehicle according to still another embodiment of the present invention.

Referring to FIG. 3, in operation S110, the computing device 100 may extract features from a plurality of pieces of scan data.

In various embodiments, the computing device 100 may extract the features from the plurality of pieces of scan data in consideration of the driving environment features of the autonomous vehicle 10.

Here, the scan data may be sensor data in the form of a point cloud collected as a predetermined space is scanned through a sensor (e.g., a light detection and ranging (LiDAR) sensor), but the present invention is not limited thereto, and the scan data may be a precision map in the form of a point cloud generated by processing sensor data collected in advance for a predetermined space. Further, the scan data may be data in the form of a LiDAR range image, but the present invention is not limited thereto.

In various embodiments, the computing device 100 may generate ground data and non-ground data by dividing specific scan data, and extract features from each of the ground data and the non-ground data in consideration of the driving environment features of the autonomous vehicle 10.

Here, the ground data may be data that includes only scan points corresponding to the ground surface among a plurality of scan points included in the specific scan data, and the non-ground data may be data that includes scan points corresponding to the remaining scan points excluding the ground surface among the plurality of scan points included in the specific scan data (i.e., data in which only the scan points corresponding to the ground surface are removed from the specific scan data). Hereinafter, an operation of extracting features performed by the computing device 100 will be described with reference to FIGS. 4 to 8.

FIG. 4 is a flowchart for describing a method of extracting features corresponding to road markers from ground data in various embodiments.

Referring to FIG. 4, in various embodiments, the computing device 100 may extract features corresponding to road markers from ground data in consideration of the driving environment features of the autonomous vehicle 10.

In operation S210, when ground data is generated by dividing specific scan data, the computing device 100 may set a feature extraction area on the ground data.

Here, the feature extraction area may be set based on the type of sensor that collects the specific scan data and the position of the sensor. For example, when the sensor that collects the scan data is a LiDAR sensor, a certain range of area (e.g., a range of 45 m front and rear, 10 m left and right, and −1.5 m to 2.5 m in height) may be set as the feature extraction area on the basis of the position of the LiDAR sensor, but the present invention is not limited thereto.

In operation S220, the computing device 100 may extract at least one scan point whose intensity is greater than or equal to a predetermined value from among the plurality of scan points included in the feature extraction area set by performing operation S210.

Here, the intensity may be a value returned when a signal output through the sensor is reflected by an object, that is, an intensity value of the reflected signal.

Further, here, the predetermined value is an intensity value that serves as a standard for selecting scan points with high reflectivity, and may be a preset value, for example, 0.01, 0.02, 0.03, 0.05, or 0.1, but the present invention is not limited thereto.

In operation S230, the computing device 100 may extract first features on the basis of the scan points extracted in operation S220.

For example, the computing device 100 may assign at least one scan point whose intensity is greater than or equal to a predetermined value from among the plurality of scan points included in the feature extraction area as a road marker, and extract the scan points assigned as the road marker as the first features.

As another example, the computing device 100 may assign at least one scan point whose intensity is greater than or equal to a predetermined value from among the plurality of scan points included in the feature extraction area as a road marker, and extract edges generated by the scan points assigned as the road marker as the first features.

That is, the computing device 100 may set the feature extraction area on the ground data in consideration of the driving environment feature that the road marker is present on the ground surface, and select scan points with an intensity greater than or equal to a predetermined value from among the scan points included in the feature extraction area in consideration of the driving environment feature that the road marker has high reflectivity, and through this, the computing device 100 may accurately extract the features corresponding to the road marker from the scan data.

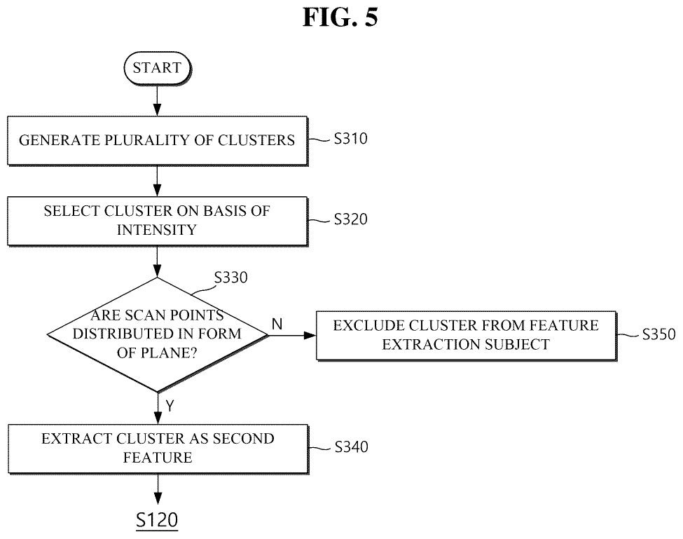

FIG. 5 is a flowchart for describing a method of extracting features corresponding to road traffic signs from non-ground data in various embodiments.

Referring to FIG. 5, in various embodiments, the computing device 100 may extract features corresponding to road traffic signs from non-ground data in consideration of the driving environment features of the autonomous vehicle 10.

In operation S310, when non-ground data is generated by dividing specific scan data, the computing device 100 may generate a plurality of clusters by clustering a plurality of scan points included in the non-ground data.

For example, the computing device 100 may classify adjacent scan points into one cluster for a plurality of scan points included in the non-ground data, and when the distances between the scan points change significantly, the computing device 100 may generate a plurality of clusters by classifying the respective scan points into different clusters.

In operation S320, the computing device 100 may select at least one cluster from among the plurality of clusters on the basis of the intensity of the scan point. For example, the computing device 100 may select at least one cluster in which the intensity of the scan points is greater than or equal to a predetermined value from among the plurality of clusters, but the present invention is not limited thereto.

Further, here, the predetermined value is an intensity value that serves as a standard for selecting clusters including scan points with high reflectivity, and may be a preset value, for example, 0.7, 0.8, or 0.9, but the present invention is not limited thereto. In operation S330, the computing device 100 may determine whether the scan points included in the cluster selected by performing operation S320 are distributed in the form of a plane.

More specifically, first, the computing device 100 may calculate a covariance matrix for the scan points included in the cluster. Here, the covariance matrix may include information about three eigenvalues corresponding to each of three mutually perpendicular axis directions.

Thereafter, the computing device 100 may determine the form of the distribution of the scan points included in the cluster on the basis of the sizes of the three eigenvalues. For example, when the sizes of two eigenvalues among the three eigenvalues are greater than or equal to a threshold value (e.g., 0.9) and the size of the remaining one eigenvalue is less than the threshold value, the computing device 100 may determine that the scan points included in the cluster are distributed in the form of a plane.

In operation S340, when it is determined that scan points included in a specific cluster are distributed in the form of a plane in operation S330, the computing device 100 may extract a specific cluster as second features. For example, as illustrated in FIG. 6, when scan points included in a specific cluster 21 are distributed in the form of a plane, the computing device 100 may assign the specific cluster 21 as a road traffic sign and extract a plane generated by the scan points included in the cluster assigned as the road traffic sign as the second features.

In operation S350, when it is determined that the scan points included in the cluster are not distributed in the form of a plane in operation S330, the computing device 100 may classify the corresponding cluster as other (etc.) and extract an edge and/or plane generated by the scan points included in the cluster classified as other as features.

That is, the computing device 100 may use the non-ground data among the scan data in consideration of the driving environment feature that road traffic signs are floating at a certain height relative to the ground surface, and select the cluster in which the intensity of the scan points is greater than or equal to a predetermined value and are distributed in the form of a plane in consideration of the driving environment feature that road traffic signs have high reflectivity and a planar shape, and through this, the computing device 100 may accurately extract the features corresponding to the road traffic signs from the scan data.

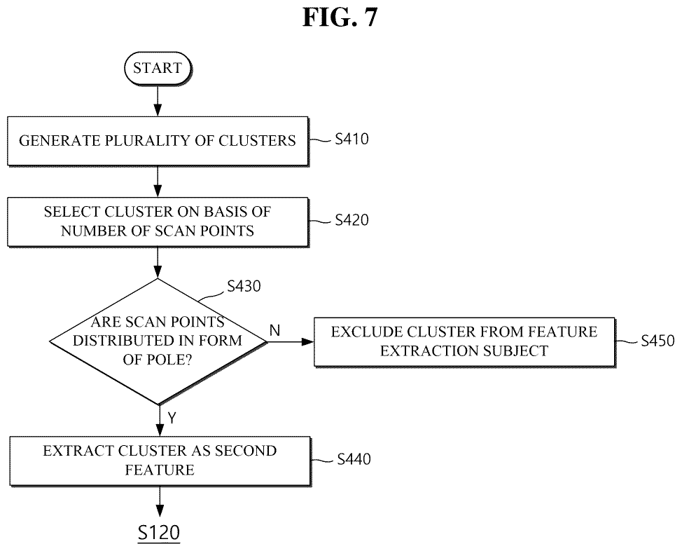

FIG. 7 is a flowchart for describing a method of extracting features corresponding to pole-like objects from non-ground data in various embodiments.

Referring to FIG. 7, in various embodiments, the computing device 100 may extract features corresponding to a pole (or pole-like object) from non-ground data in consideration of the driving environment features of the autonomous vehicle 10.

In operation S410, when non-ground data is generated by dividing specific scan data, the computing device 100 may generate a plurality of clusters by clustering a plurality of scan points included in the non-ground data. Here, the clustering method performed by the computing device 100 may be implemented in the same or a similar form as in operation S310 of FIG. 5, but the present invention is not limited thereto.

In operation S420, the computing device 100 may select at least one cluster from among the plurality of clusters on the basis of the number of scan points in order to primarily select a valid cluster. For example, the computing device 100 may select a cluster that includes a predetermined number or more of scan points from among the plurality of clusters.

In various embodiments, for the purpose of extracting features corresponding to poles from scan data, the computing device 100 may select a cluster that includes a first number (e.g., 30) or more of scan points and at the same time has a second number (e.g., 6) or more of scan points in a specific direction, from among the plurality of clusters, but the present invention is not limited thereto.

In operation S430, the computing device 100 may determine whether the scan points included in the cluster selected by performing operation S420 are distributed in the form of a pole.

More specifically, first, the computing device 100 may calculate a covariance matrix for the scan points included in the cluster. Here, the covariance matrix may include information about three eigenvalues corresponding to each of three mutually perpendicular axis directions.

Thereafter, the computing device 100 may determine the form of the distribution of the scan points included in the cluster on the basis of the sizes of the three eigenvalues. For example, when the size of one eigenvalue among the three eigenvalues is greater than or equal to a first threshold value (e.g., 0.25) and the sizes of the remaining two eigenvalues are less than a second threshold value (e.g., 0.005), the computing device 100 may determine that the scan points included in the cluster are distributed in the form of a pole.

In various embodiments, the computing device 100 may determine the form of the distribution of the scan points included in the specific cluster by performing principal component analysis on the specific cluster.

In various embodiments, the computing device 100 may determine the form of the distribution of the scan points included in the specific cluster using singular value decomposition (SVD) for the specific cluster.

In various embodiments, when a z-axis component value of a unit vector in a long-axis direction of the distribution of the scan points included in the specific cluster is greater than or equal to a preset value (e.g., 0.8), the computing device 100 may determine that the scan points included in the specific cluster are distributed in the form of a pole.

In operation S440, when it is determined that the scan points included in the cluster are distributed in the form of a pole in operation S430, the computing device 100 may extract the corresponding cluster as second features. For example, as illustrated in FIG. 8, when it is determined that scan points included in a specific cluster 22 are distributed in the form of a pole, the computing device 100 may assign the specific cluster 22 as a pole (or pole-like object), and extract an edge generated by the scan points included in the cluster assigned as the pole (or pole-like object) as the second features.

In operation S450, when it is determined that the scan points included in the cluster are not distributed in the form of a pole in operation S430, the computing device 100 may classify the corresponding cluster as other (etc.) and extract the edge and/or plane generated by the scan points included in the cluster classified as other as features.

In various embodiments, the computing device 100 may select the cluster in which the scan points are distributed in the form of a pole from among the plurality of clusters in consideration of the fact that there are many pole-like objects, such as trees, electric poles, traffic lights, and the like in the driving environment and of the driving environment feature that these pole-like objects are distributed in a long vertical direction, and through this, the computing device 100 may accurately extract the features corresponding to the pole (or pole-like object) from the scan data.

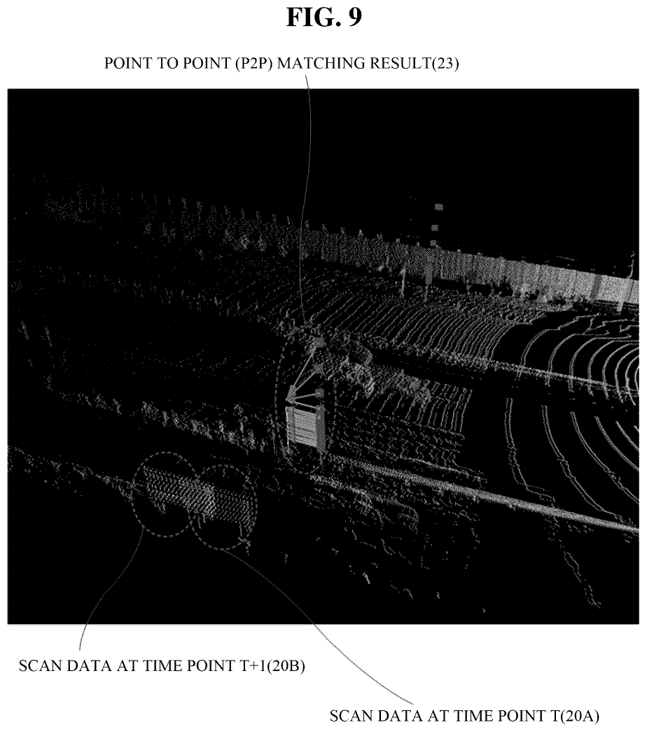

Referring to FIG. 3 again, in operation S120, the computing device 100 may match a plurality of pieces of scan data using the features extracted by performing operation S110 (e.g., FIG. 9).

In various embodiments, as illustrated in FIG. 9, when the computing device 100 intends to match scan data collected at two consecutive time points, for example, first scan data 20A collected at a first time point T and second scan data 20B collected at a second time point T+1 after the first time point, the computing device 100 may derive a relative transformation 23 between a coordinate system of the first scan data and a coordinate system of the second scan data by matching features extracted from the first scan data with features extracted from the second scan data.

Here, deriving the relative transformation between the coordinate system of the first scan data and the coordinate system of the second scan data may mean calculating a transformation matrix for converting coordinates of the first scan data to coordinates of the second scan data, but the present invention is not limited thereto.

Further, here, the method of matching the scan data based on the driving environment features of the autonomous vehicle according to various embodiment of the present invention is described as matching the scan data on the basis of the features corresponding to the road markers, the road traffic signs, and the poles (or pole-like objects) that are extracted from the scan data, but the present invention is not limited thereto, and the scan data may be matched using not only the features corresponding to the road markers, the road traffic signs, and the poles (or pole-like objects), but also features used in the conventional method of matching scan point.

For example, when matching two or more different pieces of scan data, the computing device 100 may utilize not only the features (e.g., features extracted without considering the driving environment features of the autonomous vehicle) in the form of a line and/or plane extracted from each of the two or more different pieces of scan data using a typical method of extracting features, but also the features corresponding to the road markers, the road traffic signs, and the poles that are extracted from each of the two or more different pieces of scan data using the method of matching the scan data based on the driving environment features of the autonomous vehicle according to various embodiments of the present invention to match the two or more different pieces of scan data, and thus the matching accuracy and robustness of two or more pieces of scan data can be secured.

In various embodiments, when the computing device 100 intends to match first scan data and second scan data, which are two different pieces of scan data, the computing device 100 may perform point to point (P2P) matching for matching scan points included in the first scan data with scan points included in the second scan data on the basis of features extracted from the first scan data and features extracted from the second scan data. In this case, when the computing device 100 intends to perform P2P matching between the first scan data and the second scan data, the computing device 100 may match the scan points included in the first scan data and the scan points included in the second scan data on the basis of the distances between the scan points.

In various embodiments, when the computing device 100 intends to match first scan data and second scan data, which are two different pieces of scan data, the computing device 100 may perform point to edge (P2E) matching for matching scan points included in the first scan data with features in the form of an edge extracted from the second scan data or match features in the form of an edge extracted from the first scan data and scan points included in the second scan data, on the basis of features extracted from the first scan data and features extracted from the second scan data.

In various embodiments, when the computing device 100 intends to match first scan data and second scan data, which are two different pieces of scan data, the computing device 100 may perform point to plane (P2PL) matching for matching scan points included in the first scan data with features in the form of a plane extracted from the second scan data or match features in the form of a plane extracted from the first scan data with scan points included in the second scan data, on the basis of features extracted from the first scan data and features extracted from the second scan data.

In various embodiments, when the computing device 100 intends to match first scan data and second scan data, which are two different pieces of scan data, the computing device 100 may match the first scan data and the second scan data so that the distances between features extracted from the first scan data and features extracted from the second scan data have minimum values.

More specifically, first, the computing device 100 may determine features corresponding to each other among a plurality of features extracted from the first scan data and a plurality of features extracted from the second scan data. For example, the computing device 100 may match first features and second features that are located at the closest distance on the basis of the distances between a plurality of first features extracted from the first scan data and a plurality of second features extracted from the second scan data. Here, in the process of finding features located at the closest distance, a data structure (e.g., k-d tree) in which point data is stored may be utilized, but the present invention is not limited thereto.

Thereafter, the computing device 100 may use the distances between the features corresponding to each other as a cost function to determine scan data matching that minimizes the cost. That is, the first scan data and the second scan data may be matched so that the cost has a minimum value using the distances between the first features and the second features corresponding to each other as a cost function.

The method of matching the scan data based on the driving environment features of the autonomous vehicle has been described above with reference to the flowcharts illustrated in the drawings. For a brief description, the method of matching the scan data based on the driving environment features of the autonomous vehicle has been illustrated and described as a series of blocks, but the present invention is not limited to the order of the blocks, and some blocks may be performed in a different order from those illustrated and performed herein or may be performed simultaneously. In addition, new blocks that are not described in this specification and drawings may be added and performed or some blocks may be deleted or may be performed with changes.

According to embodiments of the present invention, by extracting features from scan data in consideration of the driving environment features of the autonomous vehicle and matching the scan data on the basis of the extracted features, scan data matching optimized for the driving environment of the autonomous vehicle can be performed, and through this, performance in terms of calculation amount, accuracy, and robustness can be improved.

Effects of the present invention are not limited to the above-described effects and other effects which have not been described may be clearly understood by those skilled in the art from the above descriptions.

While embodiments of the present invention have been described with reference to the accompanying drawings, it will be understood by those skilled in the art that various modifications can be made without departing from the scope of the invention concept and without changing essential features. Therefore, the above-described embodiments should be considered in a descriptive sense only and not for purposes of limitation.

What is claimed is:

1. A method of matching scan data based on driving environment features of an autonomous vehicle that is performed by a computing device, the method comprising:
extracting features from a plurality of pieces of scan data in consideration of driving environment features of an autonomous vehicle; and
performing matching on the plurality of pieces of scan data using the extracted features.

2. The method of claim 1, wherein the extracting of the features includes:
generating ground data and non-ground data by dividing scan points corresponding to a ground surface among a plurality of scan points included in specific scan data;
extracting a first feature from the generated ground data; and
extracting a second feature from the generated non-ground data.

3. The method of claim 2, wherein the extracting of the first feature includes:
setting a feature extraction area on the generated ground data on the basis of a type of sensor that collects the specific scan data and a position of the sensor;
extracting at least one scan point whose intensity is greater than or equal to a predetermined value from among a plurality of scan points included in the set feature extraction area; and
extracting at least one of the extracted at least one scan point and an edge generated by the extracted at least one scan point as the first feature.

4. The method of claim 2, wherein the extracting of the second feature includes:
generating a plurality of clusters by clustering a plurality of scan points included in the generated non-ground data;
selecting a cluster whose intensity is greater than or equal to a predetermined value from among the plurality of generated clusters; and
when scan points included in the selected cluster are distributed in a form of a plane, extracting the selected cluster as the second feature.

5. The method of claim 4, wherein the extracting of the selected cluster as the second feature includes:
calculating a covariance matrix for the scan points included in the selected cluster, wherein the calculated covariance matrix includes three eigenvalues corresponding to each of three mutually perpendicular axis directions; and
when sizes of two of the three eigenvalues are greater than or equal to a threshold value and a size of the remaining one eigenvalue is less than the threshold value, extracting a plane generated by the scan points included in the selected cluster as the second feature.

6. The method of claim 2, wherein the extracting of the second feature includes:
generating a plurality of clusters by clustering a plurality of scan points included in the generated non-ground data;
selecting a cluster including a predetermined number or more of scan points from among the plurality of generated clusters; and
when scan points included in the selected cluster are distributed in a form of a pole, extracting the selected cluster as the second feature.

7. The method of claim 6, wherein the extracting of the selected cluster as the second feature includes:
calculating a covariance matrix for the scan points included in the selected cluster, wherein the calculated covariance matrix includes three eigenvalues corresponding to each of three mutually perpendicular axis directions; and
when a size of one of the three eigenvalues is greater than or equal to a first threshold value and sizes of the remaining two eigenvalues are less than a second threshold value smaller than the first threshold value, extracting an edge generated by the scan points included in the selected cluster as the second feature.

8. The method of claim 6, wherein the extracting of the selected cluster as the second feature includes, when a z-axis component value of a unit vector in a long-axis direction of the distribution of the scan points included in the selected cluster is greater than or equal to a preset value, extracting an edge generated by the scan points included in the selected cluster as the second feature.

9. The method of claim 6, wherein the extracting of the selected cluster as the second feature includes, when distances between two or more clusters extracted as the second feature are less than or equal to a predetermined distance, removing remaining clusters except for any one of the two or more clusters.

10. The method of claim 1, wherein the plurality of pieces of scan data include first scan data collected at a first time point and second scan data collected at a second time point after the first time point, and
in the performing of the matching, a relative transformation between a coordinate system of the first scan data and a coordinate system of the second scan data is derived by matching a feature extracted from the first scan data with a feature extracted from the second scan data, wherein the feature extracted from the first scan data and the feature extracted from the second scan data include features extracted in consideration of the driving environment features of the autonomous vehicle.

11. The method of claim 1, wherein the plurality of pieces of scan data include first scan data and second scan data, and
the performing of the matching includes:
finding correspondences between a plurality of features extracted from the first scan data and a plurality of features extracted from the second scan data on the basis of distances between the plurality of features extracted from the first scan data and the plurality of features extracted from the second scan data; and
matching the first scan data with the second scan data using the distances between the plurality of features extracted from the first scan data and the plurality of features extracted from the second scan data that correspond to each other as a cost function so that a cost of the cost function has a minimum value.

12. A computing device for performing a method of matching scan data based on driving environment features of an autonomous vehicle, the computing device comprising:
a processor;
a network interface;
a memory; and
a computer program that is loaded into the memory and executed by the processor,
wherein the computer program includes:
an instruction for extracting features from a plurality of pieces of scan data in consideration of driving environment features of an autonomous vehicle; and
an instruction for performing matching on the plurality of pieces of scan data using the extracted features.

13. A recording medium readable by a computing device that is combined with a computing device and on which a computer program for performing a method of matching scan data based on driving environment features of an autonomous vehicle is recorded,
wherein the method includes:
extracting features from a plurality of pieces of scan data in consideration of driving environment features of an autonomous vehicle; and
performing matching on the plurality of pieces of scan data using the extracted features.
